(19) United States
(12) Patent Application Publication
(10) Pub. No.: US 2014/0177912 A1
(43) Pub. Date: Jun. 26, 2014

(54) COMMODITY READING APPARATUS, COMMODITY SALES DATA PROCESSING APPARATUS AND COMMODITY READING METHOD

(71) Applicant: TOSHIBA TEC KABUSHIKI KAISHA, Tokyo (JP)

(72) Inventor: Atsushi Okamura, Miyagi-ken (JP)

(73) Assignee: TOSHIBA TEC KABUSHIKI KAISHA, Tokyo (JP)

(21) Appl. No.: 14/065,503

(22) Filed: Oct. 29, 2013

(30) Foreign Application Priority Data
Oct. 31, 2012 (JP) 2012-240641

(51) Int. Cl. G06K 9/00

(52) U.S. Cl. CPC G06K 9/00624
USPC 382/103

(57) ABSTRACT

In accordance with one embodiment, a determination unit configured to determine whether or not the object discriminated by the discrimination unit passes through a second area specified different from a first area in a frame range during movement of the object to the first area specified in the frame range of the animation, a first recognition unit configured to recognize a candidate commodity as a candidate of a sales commodity based on a feature amount appeared on the object in the first area if the determination unit determines that the object passes through the second area, and a second recognition unit configured to recognize a commodity data represented by an optical mark on the object in the first area if the determination unit determines that the object does not pass through the second area.

### CROSS-REFERENCE TO RELATED APPLICATION

This application is based upon and claims the benefit of priority from Japanese Patent Application No. 2012-240641, filed Oct. 31, 2012, the entire contents of which are incorporated herein by reference.

### FIELD

Embodiments described herein relate to a commodity reading apparatus, a commodity sales data processing apparatus and a commodity reading method.

### BACKGROUND

The commodity recognition for registering a sales commodity in a POS (point-of-sales) terminal and the like is generally carried out by utilizing an optical mark or symbol such as a bar code.

On the other hand, a commodity reading apparatus called as an object recognition scanner and the like utilizing an object recognition technology is proposed. The object recognition scanner recognizes a commodity based on the appearance feature of the commodity.

Although the object recognition scanner is capable of recognizing a commodity without an optical mark, the commodity recognition is low in accuracy compared with the recognition carried out by utilizing the optical mark.

Therefore, a commodity reading apparatus having two functions of carrying out the commodity recognition using the optical mark and carrying out the commodity recognition using the object recognition becomes useful.

In a case in which the optical mark is read and the appearance of the commodity is photographed by using a same image capturing device, it is difficult to instantly and automatically determine which one of the commodity recognitions should be used based on a captured image.

Therefore, an operator needs to, for example, operate a button to designate a recognition method, which becomes a burden for the operator.

If respective image capturing devices are used to read the optical mark and capture the appearance of a commodity, an operator holds a commodity to any one of the image capturing devices, thereby a recognition method can be distinctively used, but as more than two image capturing devices are required, the component cost rises.

### BRIEF DESCRIPTION OF THE DRAWINGS

FIG. 1 is an external view of a store checkout system comprising a commodity reading apparatus according to one embodiment;

FIG. 2 is a block diagram of electronic components in the store checkout system shown in FIG. 1;

FIG. 3 is a diagram illustrating an example of the definition of each functional area based on setting information included in an area setting table;

FIG. 4 is a flowchart of commodity reading processing;

FIG. 5 is a flowchart of recognition processing;

FIG. 6 is a flowchart of output processing;

FIG. 7 is a diagram illustrating a positional relationship between line of flow of a sales commodity moved by an operator and a frame range;

FIG. 8 is a diagram illustrating a positional relationship between line of flow of a sales commodity moved by an operator and a frame range;

FIG. 9 is a diagram illustrating an example of a guidance image;

FIG. 10 is a diagram illustrating an example of a guidance image; and

FIG. 11 is a diagram illustrating a modification example of the definition of each functional area.

### DETAILED DESCRIPTION

In accordance with one embodiment, a commodity reading apparatus comprises a discrimination unit, a determination unit, a first recognition unit and a second recognition unit. The discrimination unit discriminates an object included in an animation captured by an image capturing device. The determination unit determines whether or not the object discriminated by the discrimination unit passes through a second area specified in a frame range different from a first area during movement of the object to the first area specified in the frame range of the animation. The first recognition unit recognizes a candidate commodity as a candidate of a sales commodity based on a feature amount appeared on the object in the first area if the determination unit determines that the object passes through the second area. The second recognition unit recognizes a commodity data represented by an optical mark on the object in the first area when if the determination unit determines that the object does not pass through the second area.

Hereinafter, an embodiment of the commodity reading apparatus will be described with reference to the accompanying drawings. The embodiment shows a case in which the present invention is applied to a vertical type commodity reading apparatus vertically installed on a checkout counter arranged in a store such as a supermarket and the like.

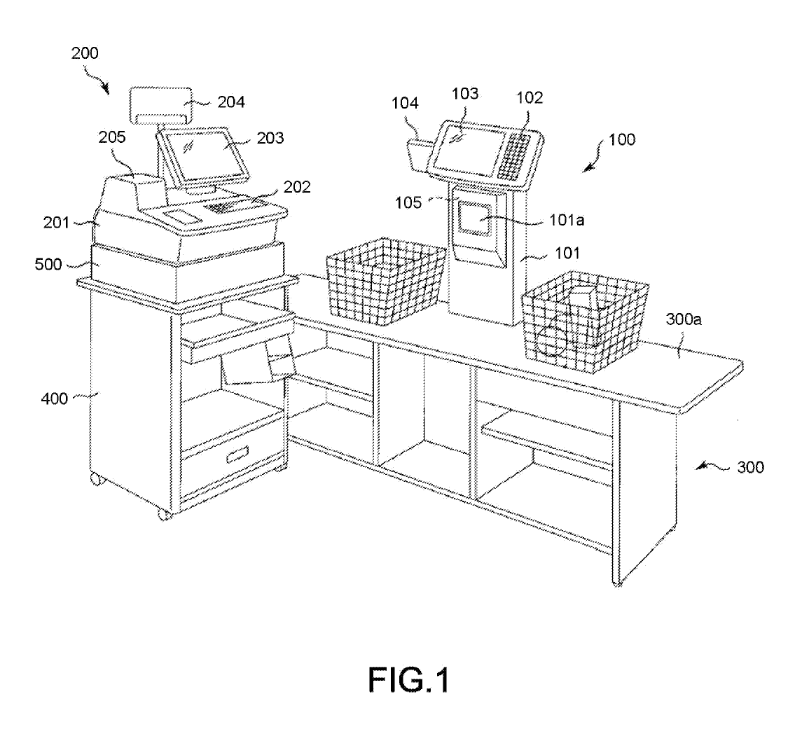

FIG. 1 is an external view of a store checkout system comprising the commodity reading apparatus according to the present embodiment. The store checkout system comprises a commodity reading apparatus 100 and a POS (point of sales) terminal 200. The commodity reading apparatus 100 is arranged on a checkout counter 300. The POS terminal 200 is arranged on a drawer 500 placed on a register table 400. The commodity reading apparatus 100 is electrically connected with the POS terminal 200 through a communication cable (not shown). Instead of the drawer 500, an automatic change dispensing machine can be arranged.

The commodity reading apparatus 100 comprises a housing 101, a keyboard 102, a touch panel 103, a display for customer 104 and an image capturing section 105.

The housing 101 is in a flat box shape, and is arranged on the checkout counter 300. The housing 101 supports the keyboard 102, the touch panel 103 and the display for customer 104 at an upper end, and supports the image capturing section 105 at the inside thereof. The housing 101 comprises a reading window 101a opposite to the image capturing section 105, and is capable of capturing an object positioned in front of the reading window 101a through the reading window 101a by utilizing the image capturing section 105.

The POS terminal 200 comprises a housing 201, a keyboard 202, a display for operator 203, a display for customer 204 and a printer 205.

The housing 201 supports the keyboard 202 in a state that a part of the keyboard 202 is exposed outwards, supports the display for operator 203 and the display for customer 204 in a state that the display for operator 203 and the display for customer 204 are positioned at the outside thereof, and supports the printer 205 at the inside thereof.

The checkout counter 300 includes an elongated top plate 300a. The checkout counter 300 divides a space into a customer passage (a rear side in FIG. 1) and an operator space (a front side in FIG. 1) along the longitudinal direction of the top plate. The housing 101 is positioned at the approximate center of the top plate 300a in the longitudinal direction such that the display for customer 104 is directed to the customer passage while the keyboard 102, the touch panel 103 and the reading window 101a is respectively directed to the operator space. One area of the surface of the top plate 300a at the upstream side of the commodity reading apparatus 100 in the customer movement direction serves as a space for placing an unregistered commodity purchased by a customer, and in addition, the other area at the downstream side of the commodity reading apparatus 100 serves as a space for placing a registered commodity. In this way, generally, the sales commodity is moved from the area at the upstream side in the customer movement direction to the area at the downstream side via an area in front of the reading window 101a. That is, the line of flow direction of the sales commodity during a sales registration is basically consistent with the customer movement direction. The standard line of flow of the sales commodity (herein after referred to as a standard line of flow) is in a horizontal direction from a right side to a left side in FIG. 1.

The register table 400 is positioned at the operator space side such that it locates side by side with an end part of the checkout counter 300 at the downstream side in the movement direction of a customer along the customer passage.

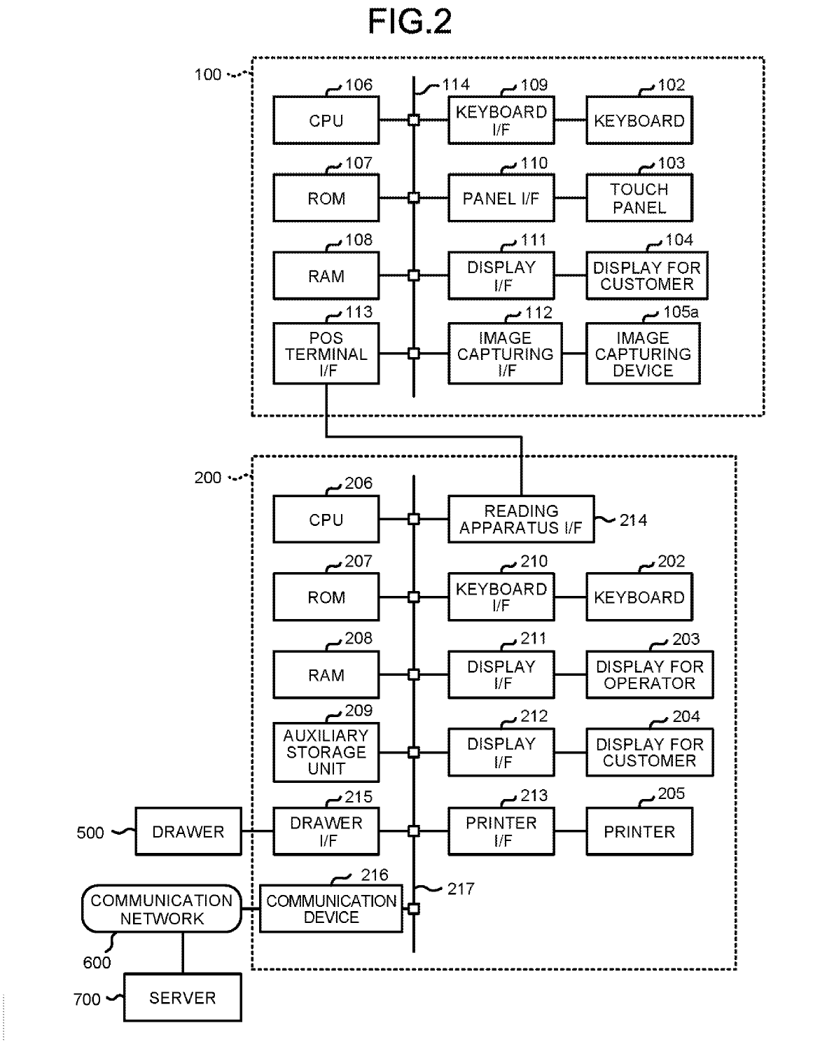

FIG. 2 is a block diagram of electronic components in the store checkout system shown in FIG. 1. In the components shown in FIG. 2, same numerals in FIG. 1 are applied to similar elements in FIG. 2.

Besides the keyboard 102, the touch panel 103 and the display for customer 104, the commodity reading apparatus 100 further comprises an image capturing device 105a, a CPU (central processing unit) 106, a ROM (read-only memory) 107, a RAM (random-access memory) 108, a keyboard interface (keyboard I/F) 109, a panel interface (panel I/F) 110, a display interface (display I/F) 111, an image capturing interface (image capturing I/F) 112, a POS terminal interface (POS terminal I/F) 113 and a bus line 114 which serve as the electronic components. The bus line 114, which comprises an address bus, a data bus and the like, connects the CPU 106, the ROM 107, the RAM 108, the keyboard interface 109, the panel interface 110, the display interface 111, the image capturing interface 112 and the POS terminal interface 113 with each other.

The keyboard 102 comprises a plurality of key switches, and outputs a command representing content of an operation on these key switches carried out by an operator.

The touch panel 103 comprises, for example, a display device such as an LCD (liquid crystal display) and the like, and a transparent two-dimensional touch sensor overlaid on a display screen of the display device. The touch panel 103 displays an image on the display device under the control of the CPU 106. The touch panel 103 detects a touch position of an operator on the display screen of the display device by the two-dimensional touch sensor, and outputs coordinate data representing the touch position detected. The touch panel 103 is used for displaying an image representing various kinds of information informed to the operator, and moreover, is used for inputting an operation or command by the operator.

The display for customer 104 displays a character string or image under the control of the CPU 106. The display for customer 104 is used for displaying various character strings or images showing to a customer. The display for customer 104 may be, for example, a fluorescent tube display or an LCD.

The image capturing device 105a is included in the image capturing section 105 together with an image capturing lens (not shown). The image capturing device 105a comprises a CCD (charge coupled device) image capturing element serving as an area image sensor and a drive circuit thereof. The image capturing lens focuses an image of an image capturing area on the CCD image capturing element. The image capturing area is referred to as an area which is focused on the area of the CCD image capturing element from the reading window 101a through the image capturing lens. The image capturing device 105a acquires frame data representing the image of the image capturing area (frame image) at regular time intervals, and outputs the frame data. In this way, an image capturing direction of the image capturing device 105a is oriented from the inside of the housing 101 towards the outside of the housing 101 via the reading window 101a. That is, the standard line of flow observed from the image capturing device 105 is extended from left to right: the left side of the frame image is the upstream side of the standard line of flow, and the right side is the downstream side.

The CPU 106 controls each component of the commodity reading apparatus 100 to realize various operations as the commodity reading apparatus 100 according to an operating system, middleware and an application program which are stored in the ROM 107 and the RAM 108.

The ROM 107 stores the operating system mentioned above. The ROM 107 may store the middleware or the application program. In addition, the ROM 107 may also store data referred when the CPU 106 carries out various kinds of processing. In the present embodiment, the ROM 107 stores an area setting table.

The area setting table includes setting information for defining various functional areas in the range of the frame image (frame range).

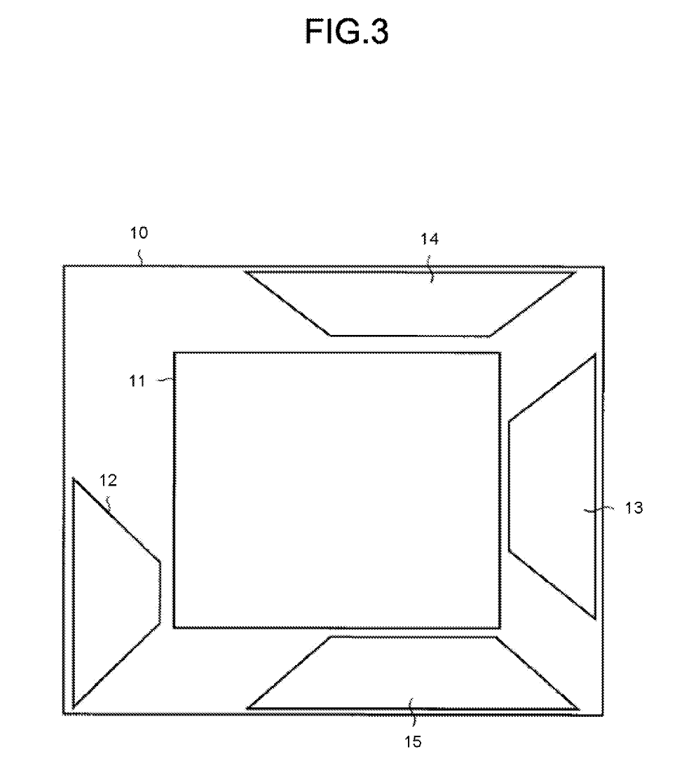

FIG. 3 is a diagram illustrating an example of the definition of each functional area based on the setting information included in the area setting table.

In the example in FIG. 3, five functional areas, namely a recognition area 11, a toggle area 12, a first candidate area 13, a second candidate area 14 and a third candidate area 15, are defined in a frame range 10.

The recognition area 11 is a rectangular area arranged at an approximate center in the frame range 10. The toggle area 12 is a trapezoidal area arranged such that it is offset downward at the end part of the upstream side (a left side in FIG. 3) of the standard line of flow in the frame range 10. The first candidate area 13 is a trapezoidal area arranged at an approximate center of the end part of the downstream side of the standard line of flow in the frame range 10. The second candidate area 14 is a trapezoidal area arranged at an upper end in the frame range 10 such that it is offset towards the downstream side of the standard line of flow. The third candidate area 15 is a trapezoidal area arranged at a lower end in the frame range 10 such that it is offset towards the downstream side of the standard line of flow. The shape of each functional area may be freely formed, respectively. In the present embodiment, the recognition area 11 corresponds to a first area, the toggle area 12 corresponds to a second area, and the first candidate area 13, the second candidate area 14 and the third candidate area 15 correspond to a plurality of third areas, respectively. In addition, the arrangements of the first candidate area 13, second candidate area 14 and third candidate area 15 are not limited to this and may be changed freely.

The RAM 108 stores data referred when the CPU 106 carries out various kinds of processing. In addition, the RAM 108, used as a so-called working area, stores data temporarily used when the CPU 106 carries out various kinds of processing. A motion table can be also stored in the RAM 108.

The application program stored in the ROM 107 or the RAM 108 includes a commodity reading program in which a processing described later is described. In addition, the transfer of the commodity reading apparatus 100 is generally performed in a state that the commodity reading program is stored in the ROM 107. The transfer of the commodity reading apparatus 100 may be performed in a state that the commodity reading program is stored in an auxiliary storage device such as an EEPROM (electric erasable programmable read-only memory), a hard disk drive or an SSD (solid state drive) and the like arranged in the commodity reading apparatus. However, the following transfer process maybe allowed. Firstly, the commodity reading apparatus 100 is transferred in a state that the commodity reading program is not stored in the ROM 107 or the auxiliary storage device. Secondly, the commodity reading program is recorded in a removable recording medium such as a magnetic disc, a magnetic optical disc, an optical disc or a semiconductor memory and the like, or transferred via a network, and the commodity reading program is written into the RAM 108 or the auxiliary storage device of the commodity reading apparatus 100 which is separately transferred as described above.

The keyboard interface 109 makes a connection between the keyboard 102 and the CPU 106 to transfer data therebetween. The keyboard interface 109 may be, for example, a well-known device based on a PS/2 standard or a USB (universal serial bus) standard.

The panel interface 110 makes a connection between the touch panel 103 and the CPU 106 to transfer data and video signal therebetween. The panel interface 110 comprises an interface for display device and an interface for touch sensor. The interface for display device may be, for example, a well-known device based on a VGA (video graphics array) standard, i.e., an analog RGB standard, a DVI (digital video interface) standard or an LVDS (low voltage differential signaling) standard. The interface for touch sensor may be, for example, a well-known device based on the USB standard or a RS (recommended standard)-232C standard.

The display interface 111 makes a connection between the display for customer 104 and the CPU 106 to transfer a video signal therebetween. The display interface 111 may be, for example, a well-known device based on the USB standard or the RS-232C standard if the display for customer 104 is a fluorescent display, or may be, for example, a well-known device based on the VGA standard, the DVI standard or the LVDS standard if the display for customer 104 is the LCD.

The image capturing interface 112 makes a connection between the image capturing device 105a and the CPU 106 to transfer data therebetween. The image capturing interface 112 may be, for example, a well-known device based on the USB standard or an IEEE (institute of electrical and electronic engineers) 1394 standard.

The POS terminal interface 113 makes a connection between the POS terminal 200 and the CPU 106 to transfer data therebetween. The POS terminal interface 113 may be, for example, a well-known device based on the USB standard or the RS-232C standard.

Besides the keyboard 202, the display for operator 203, the display for customer 204 and the printer 205, the POS terminal 200 further comprises a CPU 206, a ROM 207, a RAM 208, an auxiliary storage unit 209, a keyboard interface 210, display interfaces (display I/F) 211 and 212, a printer interface (printer I/F) 213, a reading apparatus interface (reading apparatus I/F) 214, a drawer interface (drawer I/F) 215, a communication device 216 and a bus line 217. The bus line 217, which comprises an address bus, a data bus and the like, connects the CPU 206, the ROM 207, the RAM 208, the auxiliary storage unit 209, the keyboard interface 210, the display interface 211, the display interface 212, the printer interface 213, the reading apparatus interface 214, the drawer interface 215 and the communication device 216 with each other.

The keyboard 202 comprises a plurality of key switches, and outputs a command representing content of an operation by an operator on these key switches.

The display for operator 203 displays an image under the control of the CPU 206. The display for operator 203 is used for displaying various images which are informed or notified to the operator. The display for operator 203 may be, for example, an LCD.

The display for customer 204 displays a character string or image under the control of the CPU 206. The display for customer 204 is used for displaying various character strings or images which are shown to the customer. The display for customer 204 may be, for example, a fluorescent tube display or an LCD.

The printer 205 prints a receipt image showing the content of a transaction on a receipt paper under the control of the CPU 206. The printer 205 may be well-known existing printers having various printing systems. Typically, the printer 205 is a thermal printer.

The CPU 206 controls each section to realize various operations acting as the POS terminal 200 based on an operating system, middleware and application program which are stored in the ROM 207 and the RAM 208.

The ROM 207 stores the operating system mentioned above. The ROM 207 may also store the middleware or the application program. In addition, the ROM 207 may also store data referred when the CPU 206 carries out various kinds of processing.

The RAM 208 stores data referred when the CPU 206 carries out various kinds of processing. The RAM 208 is used as a working area to also store data temporarily used when the CPU 206 carries out various kinds of processing. A part of a storage area of the RAM 208 is used as a commodity list area for managing information of the sales-registered commodity.

The auxiliary storage unit 209, which is, for example, a hard disk drive or an SSD and the like, stores data used when the CPU 206 carries out the various kinds of processing or data generated in the processing carried out by the CPU 206.

The keyboard interface 210 makes a connection between the keyboard 202 and the CPU 206 to transfer data therebetween. The keyboard interface 210 may be, for example, a well-known device based on the PS/2 standard or the USB standard.

The display interface 211 makes a connection between the display for operator 203 and the CPU 106 to transfer a video signal therebetween. The display interface 211 may be, for example, a well-known device based on the VGA standard, the DVI standard or the LVDS standard.

The display interface 212 makes a connection between the display for customer 204 and the CPU 206 to transfer a video signal therebetween. The display interface 212 may be, for example, a well-known device based on the USB standard or the RS-232C standard if the display for customer 204 is a fluorescent display, or may be, for example, a well-known device based on the VGA standard, the DVI standard or the LVDS standard if the display for customer 204 is the LCD.

The printer interface 213 makes a connection between the printer 205 and the CPU 206 to transfer data therebetween. The printer interface 213 may be, for example, a well-known device based on the USB standard, the RS-232C standard or the IEEE1284 standard (a so-called centronics specification) and the like.

The reading apparatus interface 214 makes a connection between the commodity reading apparatus 100 and the CPU 206 to transfer data therebetween. The reading apparatus interface 214 may be a well-known device based on a standard on which the POS terminal interface 113 is based.

The drawer interface 215 outputs a driving signal for opening the drawer 500 to the drawer 500 in response to an instruction from the CPU 206 to open the drawer.

The communication device 216 carries out communication with a server 700 through a communication network 600. The communication device 216 may be, for example, an existing LAN communication device.

Next, the operation by the commodity reading apparatus 100 in the store checkout system with the constitution above is described.

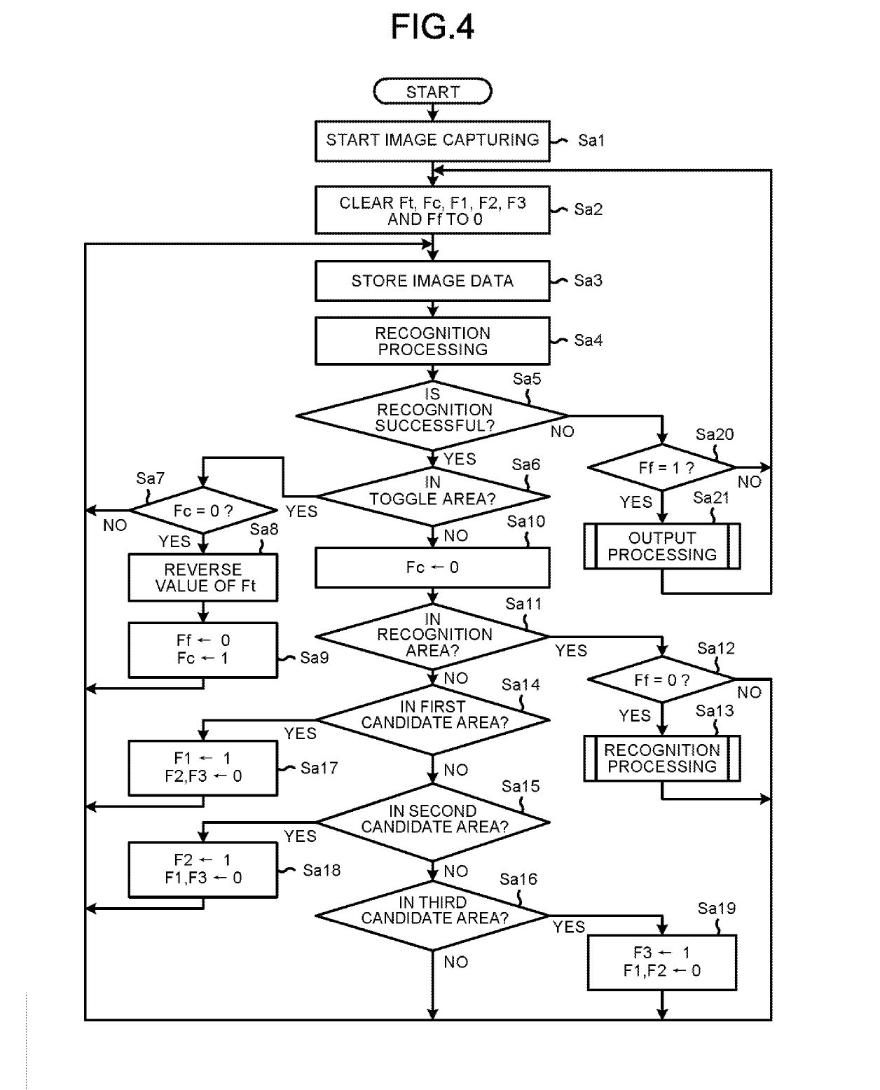

FIG. 4 is a flowchart of commodity reading processing. For example, if a sales commodity registration processing is started according to an instruction given by an operator with a specific operation on the keyboard 202, the CPU 206 sends a reading start command to the commodity reading apparatus 100 through the reading apparatus interface 214. The reading start command is notified to the CPU 106 via the POS terminal interface 113. Upon receiving the reading start command, the CPU 106 starts a commodity reading processing shown in FIG. 4. Alternatively, if a sales commodity registration processing is started according to an instruction given by an operator with a specific operation on the keyboard 102 or the touch panel 103, the CPU 106 starts a commodity reading processing shown in FIG. 4 according to the commodity reading program.

In ACT Sa1, the CPU 106 outputs an ON-signal of image capturing to the image capturing device 105a via the image capturing interface 112. Upon receiving the ON-signal of the image capturing, the image capturing device 105a starts photographing in animation. In this way, in the state, if an operator holds a sales commodity to the reading window 101a, the sales commodity is imaged in the animation by the image capturing device 105a.

In ACT Sa2, the CPU 106 clears all variables Ft, Fc, F1, F2, F3 and Ff to be 0. The values of these variables Ft, Fc, F1, F2, F3 and Ff are all set to be “0” or “1”. The value of the variable Ft is set to be “0” if a bar code recognition mode is effective, or is set to be “1” if an object recognition mode is effective. The value of the variable Fc is set to be “1” in a state that the commodity is continuously positioned in the toggle area 12. The value of the variable F1 is set to be “1” in a state that a first candidate commodity is selected. The value of the variable F2 is set to be “1” in a state that a second candidate commodity is selected. The value of the variable F3 is set to be “1” in a state that a third candidate commodity is selected. The value of the variable Ff is set to be “1” when the recognition on the commodity imaged in the animation is ended.

In ACT Sa3, the CPU 106 stores the frame data output by the image capturing device 105a in the RAM 108.

In ACT Sa4, the CPU 106 analyzes the frame data stored in the RAM 108, and recognizes the existence of the commodity included in the frame image shown by the frame data. In other words, the CPU 106 detects the commodity included in the frame image. Specifically, the CPU 106 first tries to detect a flesh color area from the frame image. If the flesh color area is detected, namely, the hand of the operator is imaged in the frame image, the CPU 106 binarizes the frame image and extracts a contour line and the like from the binary image. Thus, the CPU 106 extracts the contour of the commodity assumed to be held by the hand of the operator. In this way, the CPU 106 discriminates (detects) the commodity as an object to be recognized. The CPU 106 functions as a discrimination unit. The object may be directly discriminated (detected) by a following method. The CPU 106 first analyzes the frame data stored in the RAM 108, and extracts the contour line and the like from the image that is obtained by binarizing the frame image. Then, the CPU 106 tries to extract the contour of the object imaged in the frame image, and discriminates (detects) the existence of the object if the contour of the object can be extracted.

In ACT Sa5, the CPU 106 confirms whether or not the discrimination on the commodity is successful. If YES is taken, the CPU 106 proceeds to ACT Sa6.

In ACT Sa6, the CPU 106 confirms whether or not the position where the commodity is discriminated in the frame image is in the toggle area 12. If the commodity is discriminated in the toggle area 12, the CPU 106 performs the determination as YES in ACT Sa6, and proceeds to ACT Sa7.

In ACT Sa7, the CPU 106 confirms whether or not the value of the variable Fc is “0”. In other words, the CPU 106 confirms whether or not the commodity is in a state that it is being continuously positioned in the toggle area 12. If the value of the variable Fc is “0”, the commodity is not in the state that it is being continuously positioned in the toggle area 12. Thereafter, if the commodity newly enters the toggle area 12, the CPU 106 performs the determination as YES in ACT Sa7. Upon performing this determination, the CPU 106 proceeds to ACT Sa8.

In ACT Sa8, the CPU 106 reverses the value of the variable Ft. Namely, the CPU 106 changes the value of the variable Ft into “1” if it is “0”, or changes it into “0” if it is “1”. The CPU 106 changes a recognition mode every time the commodity imaged in the animation enters the toggle area 12.

In ACT Sa9, the CPU 106 sets the value of the variable Fc to be “1” while setting the value of the variable Ff to be “0”. That is, if the recognition mode is changed, the CPU 106 cancels the result of the commodity recognition even though the recognition on the commodity imaged in the animation is ended. Then the CPU 106 changes the variable Fc to represent the state that the commodity is continuously positioned in the toggle area 12.

If the process in ACT Sa9 is ended, the CPU 106 returns to ACT Sa3. In this case, if the value of the variable Fc is “1”, that is, if the commodity does not newly enter the toggle area 12 continuously, the CPU 106 returns to ACT Sa3 without executing ACT Sa8 and ACT Sa9.

If the position where the commodity is discriminated is not in the toggle area 12, the CPU 106 performs the determination as NO in ACT Sa6, and proceeds to ACT Sa10.

In ACT Sa10, in order to represent a state that the commodity is not continuously positioned in the toggle area 12, the CPU 106 sets the value of the variable Fc to be “0”.

In ACT Sa11, the CPU 106 confirms whether or not the position where the commodity is discriminated in the frame image is positioned in the recognition area 11. If the commodity is discriminated in the recognition area 11, the CPU 106 performs the determination as YES in ACT Sa1, and proceeds to ACT Sa12.

In ACT Sa12, the CPU 106 confirms whether or not the value of the variable Ff is “0”. If the value of the variable Ff is “0” since the discrimination on the commodity imaged in the animation is not ended, the CPU 106 performs the determination as YES in ACT Sa12, and proceeds to ACT Sa13.

In ACT Sa13, the CPU 106 executes the recognition processing according to the commodity reading program.

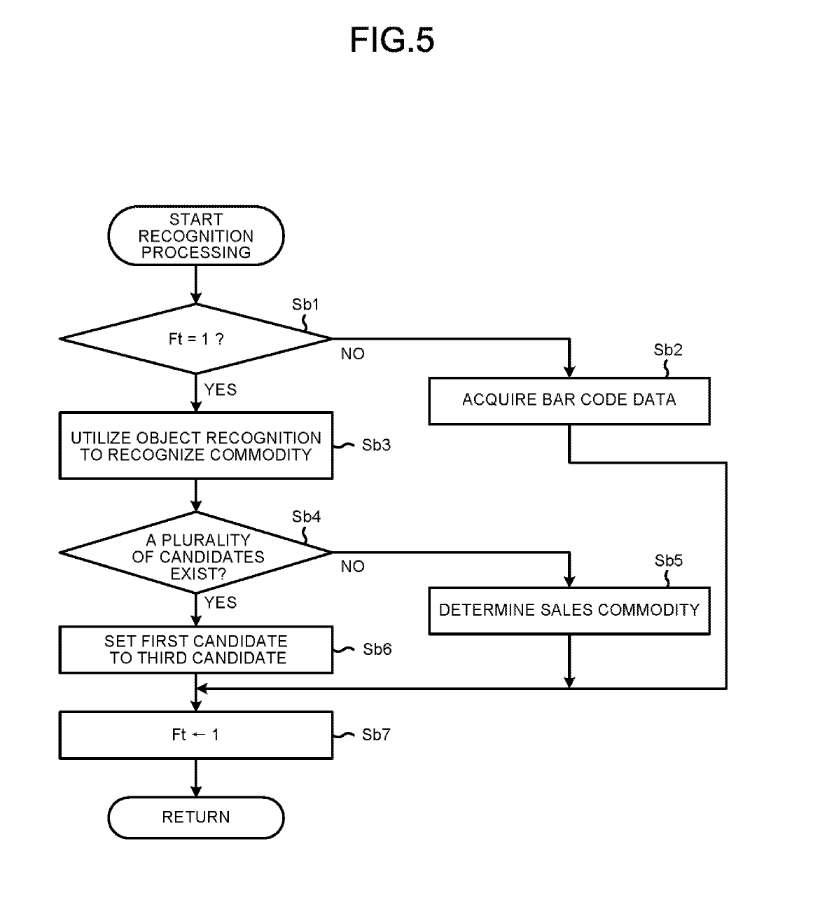

FIG. 5 is a flowchart of the recognition processing. In FIG. 4 and FIG. 5, the recognition processing is illustrated as a subroutine of the commodity reading processing, but it may be integrated with the commodity reading processing.

In ACT Sb1, the CPU 106 confirms whether or not the value of the variable Ft is “1”. If it is determined to be NO because the value of the variable Ft is “0”, the CPU 106 proceeds to ACT Sb2 from ACT Sb1. That is, if the bar code recognition mode is effective, the CPU 106 proceeds to ACT Sb2.

Since the value of the variable Ft is “0” in an initial state, the value of the variable Ft becomes “1” if the commodity newly imaged in the animation initially enters the toggle area 12, and execution of the object recognition is set. Thus, if the commodity newly imaged in the animation passes through the toggle area 12 during movement of the commodity to the recognition area 11, the value of the variable Ft is “1”. Therefore, the determination whether or not the commodity newly imaged in the animation passes through the toggle area 12 during being moved to the recognition area 11 is included in ACT Sb1, and the CPU 106 functions as a determination unit.

In ACT Sb2, the CPU 106 recognizes a bar code attached to the commodity imaged in the recognition area 11, and acquires the bar code data represented by the bar code. The CPU 106 functions as a second recognition unit. In addition, the CPU 106 writes the bar code data acquired herein in the RAM 108.

As described above, in the present embodiment, if it is determined that the commodity does not pass through the toggle area 12 during being moved to the recognition area 11, the bar code data is acquired upon taking the above determination as a trigger. However, in the determination executed by taking other event after the determination mentioned above as a trigger, the bar code data may also be acquired after the result of the determination mentioned above is confirmed.

If YES is taken in ACT Sb1 because the value of the variable Ft is “1”, the CPU 106 proceeds to ACT Sb3 from ACT Sb1. In other words, if the object recognition mode is effective, the CPU 106 proceeds to ACT Sb3.

In ACT Sb3, the CPU 106 utilizes an object recognition technology to recognize the commodity imaged in the recognition area 11. The CPU 106 functions as a first recognition unit.

Specifically, the CPU 106 reads a feature amount such as the shape, the surface hue, the pattern, the concave-convex and the like of the commodity from the image within the contour newly extracted in ACT Sa4. The CPU 106 recognizes the commodity imaged in the frame image according to the matching between the read feature amount and a feature amount previously associated with each commodity. For the recognition, a recognition dictionary file is stored in the ROM 208 or the auxiliary storage unit 209. The recognition dictionary file describes a plurality of feature amount data for each commodity being as a recognition target in association with a commodity ID (PLU code) and a commodity name for recognizing the commodity. The appearance feature amount, i.e., the surface information of the commodity (the appearance shape, the hue, the pattern, the concave-convex and the like), is extracted from a standard image obtained by photographing the commodity which is recognized with the corresponding commodity ID (PLU code), and the data representing the appearance feature amount in the form of a parameter is used as a feature amount data. The feature amount data respectively acquired from the standard images obtained by photographing the commodity in various directions for one commodity are associated with the commodity ID of the commodity. The quantity of the feature amount data for one commodity is not fixed. The quantity of the feature amount data may be different according to the commodity. The commodity name may not be necessarily included in dictionary data for each commodity.

Such a technology for recognizing a commodity is called as a general object recognition. As to the technology of the general object recognition, various recognition technologies are described in the following document, and the technology can be used in the object recognition mentioned above.

Keiji Yanai “Present situation and future of general object recognition”, Journal of Information Processing Society, Vol. 48, No. SIG16 [Search on Heisei 22 August 10], Internet <URL: http://mm.cs.uec.ac.jp/IPSJ-TCVIM-Yanai.pdf>

In addition, the technology carrying out the general object recognition by performing an area-division on the image for each object is described in the following document, and the technology can also be used in the object recognition mentioned above.

Jamie Shotton etc., “Semantic Texton Forests for Image Categorization and Segmentation”, [Search on Heisei 22 August 10], Internet <URL:http://citeseerx.ist.psu.edu/viewdoc/download?doi=10.1.1.145.3036&rep=repl&type=pdf>

As described above, in the present embodiment, the commodity recognition utilizing the object recognition is carried out on condition that the commodity passes through the toggle area 12 during movement of the commodity to the recognition area 11 as a trigger. However, in a case in which a determination is carried out by taking occurrence of other event after the determination mentioned above as a trigger, the commodity recognition utilizing the object recognition may be carried out after the determination mentioned above is confirmed.

In this way, the CPU 106 recognizes the commodity, but generally, there are many commodities similar in appearance to one another, therefore, it is not always that one commodity can be extracted, and there may also be a case that a plurality of commodities are survived as a candidate.

Therefore, in ACT Sb4, the CPU 106 confirms whether or not there is a plurality of candidate commodities. If one commodity is extracted as a candidate, the CPU 106 determines that NO is taken, and proceeds to ACT Sb5.

In ACT Sb5, the CPU 106 determines that the recognized one commodity is the sales commodity. And, the CPU 106 writes the PLU (price look up) code of the commodity determined as the sales commodity in the RAM 108.

If YES is taken in ACT Sb4 because of a plurality of candidate commodities, the CPU 106 proceeds to ACT Sb6.

In ACT Sb6, the CPU 106 sets the top three candidate commodities with high similarity degrees in the plurality of candidate commodities to be a first candidate to a third candidate in the descending order of similarity degree. Then, the CPU 106 writes each PLU code of the first candidate to the third candidate in the RAM 108.

If any one of ACT Sb2, ACT Sb5 and ACT Sb6 is ended, the CPU 106 proceeds to ACT Sb7.

In ACT Sb7, the CPU 106 sets the value of the variable Ff to be “1” to represent that the recognition on the commodity imaged in the animation is ended.

When ACT Sb7 is ended, the CPU 106 ends the recognition processing. Afterwards, the CPU 106 returns to ACT Sa3 in FIG. 4.

If No is determined because of the value of the variable Ff being “1” in ACT Sa12 in FIG. 4, the CPU 106 returns to ACT Sa3 without executing the recognition processing as mentioned above.

In a case in which the position where the commodity is recognized in the frame image is not in the recognition area 11, the CPU 106 determines that NO is taken in ACT Sa11, and proceeds to ACT Sa14.

In ACT Sa14 to ACT Sa16, the CPU 106 confirms that the position where the commodity is recognized in the frame image is in one or none of the first candidate area 13, the second candidate area 14 or the third candidate area 15. If the commodity is recognized in the first candidate area 13, the CPU 106 determines that YES is taken in ACT Sa14, and then proceeds to ACT Sa17.

In ACT Sa17, the CPU 106 sets the values of the variables F2 and F3 to be “0” while setting the value of the variable F1 to be “1”. Namely, the CPU 106 sets the variables F1, F2 and F3 as described above to represent a state that only the first candidate is selected. Then, the CPU 106 returns to ACT Sa3.

If the commodity is recognized in the second candidate area 14, the CPU 106 determines that YES is taken in ACT Sa15, and then proceeds to ACT Sa18.

In ACT Sa18, the CPU 106 sets the values of the variables F1 and F3 to be “0” while setting the value of the variable F2 to be “1”. Namely, the CPU 106 sets the variables F1, F2 and F3 as described above to represent a state that only the second candidate is selected. Then, the CPU 106 returns to ACT Sa3.

Furthermore, if the commodity is recognized in the third candidate area 15, the CPU 106 determines that YES is taken in ACT Sa16, and then proceeds to ACT Sa19.

In ACT Sa19, the CPU 106 sets the values of the variables F1 and F2 to be “0” while setting the value of the variable F3 to be “1”. Namely, the CPU 106 sets the variables F1, F2 and F3 as described above to represent a state that only the third candidate is selected. Then, the CPU 106 returns to ACT Sa3.

On the other hand, if the position where the commodity is recognized in the frame image is in none of the first candidate area 13, the second candidate area 14 and the third candidate area 15, the CPU 106 determines that NO is taken in ACT Sa16, and then returns to ACT Sa3 directly.

If the recognition on the commodity in ACT Sa4 does not succeed, the CPU 106 determines that NO is taken in ACT Sa5, and proceeds to ACT Sa20.

In ACT Sa20, the CPU 106 confirms whether or not the value of the variable Ff is “1”. If the value of the variable Ff is “1”, and thus, YES is taken, the CPU 106 proceeds to ACT Sa21. Besides, the value of the variable Ff becomes “1” immediately after the commodity on which the recognition is ended disappears in the animation.

In ACT Sa21, the CPU 106 executes output processing according the commodity reading program.

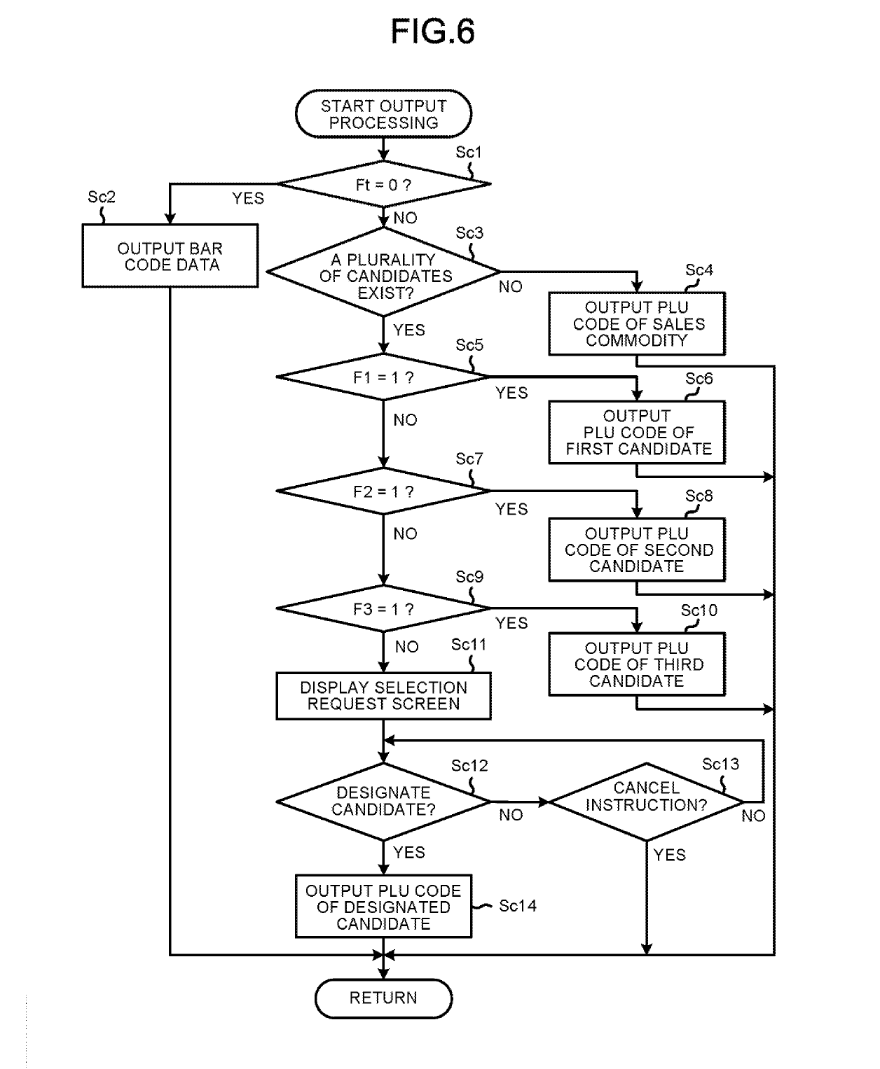

FIG. 6 is a flowchart of the output processing. In FIG. 4 and FIG. 6, the output processing is illustrated as a subroutine of the commodity reading processing, but it may be integrated with the commodity reading processing.

In ACT Sc1, the CPU 106 confirms whether or not the value of the variable Ft is “0”. If the value of the variable Ft is “0” because of the bar code recognition mode being effective, the CPU 106 determines that YES is taken, and then proceeds to ACT Sc2.

In ACT Sc2, the CPU 106 reads out the bar code data acquired in ACT Sb2 in the recognition processing from the RAM 108, and outputs the bar code data to the POS terminal 200 through the POS terminal interface 113.

On the other hand, if the value of the variable Ft is “1” because of the object recognition mode being effective, the CPU 106 determines that NO is taken in ACT Sc1, and then proceeds to ACT Sc3.

In ACT Sc3, the CPU 106 confirms whether or not there is a plurality of candidate commodities. If confirming that only one sales commodity is determined in ACT Sb5 in the recognition processing, it determines that NO is taken, and then the CPU 106 proceeds to ACT Sc4.

In ACT Sc4, the CPU 106 reads out the PLU code of the sales commodity determined in ACT Sb5 in the recognition processing from the RAM 108, and outputs the PLU code from the POS terminal interface 113 to the POS terminal 200.

On the contrary, if a plurality of candidate commodities are set in ACT Sb6 in the recognition processing, the CPU 106 determines that YES is taken in ACT Sc3, and then proceeds to ACT Sc5.

In ACT Sc5, the CPU 106 confirms whether or not the value of the variable Fl is “1”. If the value of the variable F1 is “1”, and thus, YES is taken, the CPU 106 proceeds to ACT Sc6. In other words, the CPU 106 proceeds to ACT Sc6 in a state that the first candidate is selected.

In ACT Sc6, the CPU 106 reads out the PLU code of the first candidate determined in ACT Sb5 in the recognition processing from the RAM 108, and outputs the PLU code as the PLU code of the sales commodity from the POS terminal interface 113 to the POS terminal 200.

If the CPU determines that NO is taken in ACT Sc5 because of the value of the variable F1 being “0”, the CPU 106 proceeds to ACT Sc7.

In ACT Sc7, the CPU 106 confirms whether or not the value of the variable F2 is “1”. If the value of the variable F2 is “1”, and thus, YES is taken, the CPU 106 proceeds to ACT Sc8. In other words, the CPU 106 proceeds to ACT Sc8 in a state that the second candidate is selected.

In ACT Sc8, the CPU 106 reads out the PLU code of the second candidate determined in ACT Sb5 in the recognition processing from the RAM 108, and outputs the PLU code as the PLU code of the sales commodity from the POS terminal interface 113 to the POS terminal 200.

If the CPU 106 determines that NO is taken in ACT Sc7 because of the value of the variable F2 being “0”, the CPU 106 proceeds to ACT Sc9.

In ACT Sc9, the CPU 106 confirms whether or not the value of the variable F3 is “1”. If the value of the variable F3 is “1”, and thus, YES is taken, the CPU 106 proceeds to ACT Sc10. In other words, the CPU 106 proceeds to ACT Sc10 in a state that the third candidate is selected.

In ACT Sc10, the CPU 106 reads out the PLU code of the third candidate determined in ACT Sb5 in the recognition processing from the RAM 108, and outputs the PLU code as the PLU code of the sales commodity from the POS terminal interface 113 to the POS terminal 200.

As described above, the CPU 106 functions as a selection unit.

If the CPU 106 determines that NO is taken in ACT Sc9 because of the value of the variable F3 being “0”, the CPU 106 proceeds to ACT Sc11. In this case, it is in a state that no candidate commodity is selected.

In ACT Sc11, the CPU 106 displays a selection request screen on the touch panel 103. The selection request screen is used for enabling an operator to carry out an instruction in which one of the first candidate commodity to the third candidate commodity is designated or a cancellation. The operator carries out, according to the selection request screen, the operation of designating one of the candidate commodities consistent with the sales commodity, or the operation of the cancellation instruction if none of the candidate commodities is consistent with the sales commodity. These operations can be accepted by, for example, the touch panel 103.

In ACT Sc12, the CPU 106 confirms whether or not the designation on the candidate commodity as described above is carried out. If the designation is not carried out, and thus, NO is taken in ACT Sc12, the CPU 106 proceeds to ACT Sc13.

In ACT Sc13, the CPU 106 confirms whether or not the cancellation is instructed. If the cancellation is not instructed, and thus, NO is taken herein, the CPU 106 returns to ACT Sc12.

As described above, in ACT Sc12 and ACT Sc13, the CPU 106 waits for the designation on the candidate commodity or the cancellation instruction. If the designation on the candidate commodity is carried out, the CPU 106 determines that YES is taken in ACT Sc12, and then proceeds to ACT Sc14.

In ACT Sc14, the CPU 106 reads out the PLU code of the designated candidate commodity from the RAM 108, and outputs the PLU code as the PLU code of the sales commodity from the POS terminal interface 113 to the POS terminal 200.

On the other hand, if the cancellation is instructed, and thus, YES is taken in ACT Sc13, the CPU 106 does not carry out processing in ACT Sc14. The CPU 106 finishes the output processing without outputting the PLU code of any one of candidate commodities, and then returns to ACT Sa2 in FIG. 4. In other words, the CPU 106 cancels the result of the commodity recognition performed just before.

If the data output in any one of ACT Sc2, ACT Sc4, ACT Sc6, ACT Sc8, ACT Sc10 and ACT Sc14 is ended, the CPU 106 finishes the output processing shown in FIG. 5, and returns to ACT Sa2 in FIG. 4.

In addition, if the value of the variable Ff is “0”, and thus, NO is taken in ACT Sa20 in FIG. 4, the CPU 106 returns to ACT Sa3 without executing the output processing as described above.

According to the processing described above, a sales commodity is repeatedly recognized while the operator holds the sales commodity in front of the reading window 101a, and it is confirmed whether or not the position in the frame range 10 of the sales commodity belongs to any one of the recognition area 11, the toggle area 12, the first candidate area 13, the second candidate area 14 and the third candidate area 15. And, a commodity recognition mode is changed every time the operator moves the sales commodity into the toggle area 12. When the operator moves the sales commodity into the recognition area 11, the recognition on the commodity is carried out if the recognition on the commodity is not yet ended. In the recognition carried out, the object recognition technology or the bar code recognition technology is selectively applied according to a set mode. If there is a first candidate commodity when the operator moves the sales commodity into the first candidate area 13, the first candidate commodity is determined as the sales commodity. If there is a second candidate commodity when the operator moves the sales commodity into the second candidate area 14, the second candidate commodity is determined as the sales commodity. Furthermore, if there is a third candidate commodity when the operator moves the sales commodity into the third candidate area 15, the third candidate commodity is determined as the sales commodity.

In a case that the commodity cannot be recognized, the CPU 106 clears each variables to “0” to prepare the start of recognizing a new sales commodity and waits for a condition that the recognition on the new sales commodity is enabled such that it is held in front of reading window 101a. However, immediately after the commodity cannot be recognized as the operator moves the sales commodity on which the recognition is performed away from the reading window 101a, the bar code data or the PLU code of the recognized sales commodity is sent from the commodity reading apparatus 100 to the POS terminal 200.

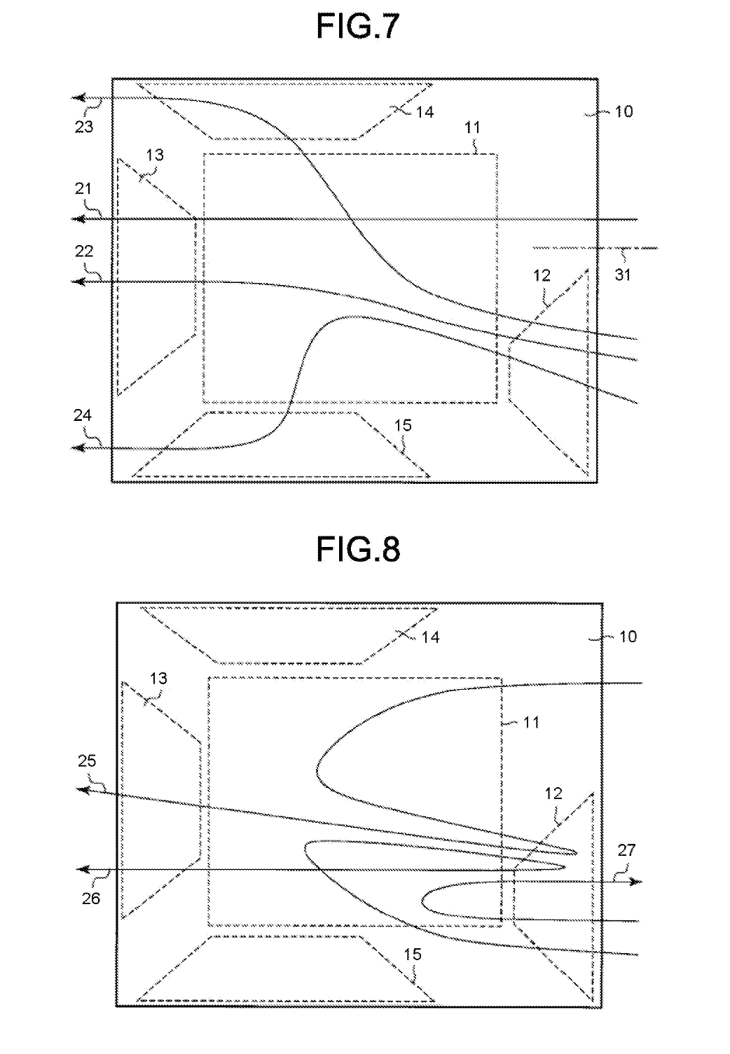

FIG. 7 is a diagram illustrating a positional relationship between the line of flow of the sales commodity moved by the operator and the frame range 10. FIG. 7 is illustrated in a direction that the operator absorbs, and therefore, each functional area is in a mirror-image relation with that in FIG. 3.

As described above, the standard line of flow of the sales commodity goes along in the horizontal direction from the right side to the left side in FIG. 1. Lines of flow 21 and 22 in FIG. 7 are actually the same as the standard line of flow.

However, since, in the line of flow 21, the sales commodity does not pass through the toggle area 12, and therefore, the commodity reading apparatus 100 tries to acquire the bar code data with the bar code recognition technology.

On the other hand, in the other line of flow 22, the sales commodity only passes through the toggle area 12 only once, and therefore, the commodity reading apparatus 100 tries to recognize the commodity with the object recognition technology. And, since the commodity only passes through the first candidate area 13 in the first candidate area 13, the second candidate area 14 and the third candidate area 15, if there are a plurality of candidate commodities, the commodity reading apparatus 100 determines the commodity with the highest similarity degree as a sales commodity in these candidate commodities.

As described above, according to the commodity reading apparatus 100, the acquirement of the bar code data with the bar code recognition technology and the recognition on the commodity with the object recognition technology can be used selectively by changing a position where the commodity is entered into the frame range at the upstream side of the line of flow by an operator even in a case in which the operator moves the sales commodity along the line of flow according to the standard line of flow. That is, the switching between the bar code recognition mode for acquiring the bar code data with the bar code recognition technology and the object recognition mode for recognizing the commodity with the object recognition technology (in other words, the setting of the bar code recognition mode and the object recognition mode) can be carried out without a mode switching (in other words, mode setting) operation, and thus the burden of the operator can be decreased compared with carrying out the mode switching operation. Moreover, the same image capturing device 105a is used in both modes, and therefore, there is no cost increase caused by the image capturing devices which are respectively arranged.

Beside, in order to enable the operator to easily recognize a position where the sales commodity with a bar code is entered into the frame range and a position where the sales commodity without a bar code is entered into the frame range, a line or a mark and the like may be formed at or near a position corresponding to the position on the housing 101 or the reading window 101a shown by a dot and dashed line 31 in FIG. 7. Alternatively, a partition plate and the like may also be arranged at a position corresponding to the position shown by the dot and dashed line 31.

Compared with the lines of flow 21 and 22, lines of flow 23 and 24 shown in FIG. 7 curve more greatly, but go from a right side toward a left side the same as the standard line of flow.

In the line of flow 23, the sales commodity passes through the toggle area 12 only once, and the commodity reading apparatus 100 tries to recognize the commodity with the object recognition technology. The commodity only passes through the second candidate area 14 within the first candidate area 13, the second candidate area 14 and the third candidate area 15, and therefore, if there are a plurality of candidate commodities, the commodity reading apparatus 100 determines the commodity with the second highest similarity degree as a sales commodity in those candidate commodities.

In the line of flow 24, the sales commodity passes through the toggle area 12 only once, and the commodity reading apparatus 100 tries to recognize the commodity with the object recognition technology. The commodity only passes through the third candidate area 15 within the first candidate area 13, the second candidate area 14 and the third candidate area 15, and therefore, if there are a plurality of candidate commodities, the commodity reading apparatus 100 determines the commodity with the third highest similarity degree as a sales commodity in those candidate commodities.

As described above, according to the commodity reading apparatus 100, one of the plurality of candidate commodities which cannot be further extracted therefrom with the object recognition technology can be determined to be the sales commodity by changing a position where the commodity is withdrawn from the frame range by the operator at the downstream side of the line of flow. In other words, the selection on one commodity from the plurality of candidate commodities can be carried out without carrying out the selection operation, and thus the burden of the operator can be reduced compared with a case in which such selection operation is carried out.

FIG. 8 is a diagram illustrating a positional relationship between the line of flow of the sales commodity moved by the operator and the frame range 10. In FIG. 8 also the same as FIG. 7, each functional area is in the mirror-image relation with those in FIG. 3.

In a line of flow 25, the commodity reading apparatus 100 first tries to acquire the bar code data with the bar code recognition technology because the sales commodity enters the recognition area 11 without passing through the toggle area 12 when the commodity is moved into the frame range. However, subsequently, the sales commodity enters the toggle area 12, then the sales commodity further enters the recognition area 11, and therefore, the commodity reading apparatus 100 retries the commodity recognition with the object recognition technology.

In this way, according to the commodity reading apparatus 100, even though the operator moves the sales commodity directly to the recognition area 11 without passing through the toggle area 12 because the operator erroneously recognizes that the commodity without a bar code may be a commodity with a bar code, the sales commodity is temporarily returned to the toggle area 12 and then moved into the recognition area 11 again. In this way, the burden of the operator can be reduced compared with a case in which movement of the sales commodity is retried along the line of flow 22 after the sales commodity is once withdrawn from the frame range.

In a line of flow 26, the commodity reading apparatus 100 first tries the commodity recognition with the object recognition technology because the commodity enters the recognition area 11 after passing through the toggle area 12 when it enters the frame range. However, subsequently, the sales commodity enters the toggle area 12, and then enters the recognition area 11, and therefore, the commodity reading apparatus 100 retries acquisition of the bar code data with the bar code recognition technology.

In this way, according to the commodity reading apparatus 100, even though the operator passes the commodity with a bar code to the recognition area 11 through the toggle area 12 because the operator erroneously recognizes that the commodity with a bar code maybe a commodity without a bar code, the sales commodity is temporarily returned to the toggle area 12 and then moved into the recognition area 11. In this way, the burden of the operator can be lightened compared with a case in which movement of the sales commodity is retried along the line of flow 21 after the sales commodity is once withdrawn from the frame range.

In a line of flow 27, the commodity reading apparatus 100 tries the commodity recognition with the object recognition technology because the sales commodity enters the recognition area 11 after passing through the toggle area 12 when it enters the frame range. However, subsequently, the sales commodity is withdrawn from the frame range without entering any one of the first candidate area 13, the second candidate area 14 and the third candidate area 15, therefore, the commodity reading apparatus 100 displays the selection request screen to enable the operator to carry out the designation on one in the first candidate commodity to the third candidate commodity or the cancellation instruction.

In this way, according to the commodity reading apparatus 100, if the sales commodity is not moved according to such a line of flow which leads the commodity as one in the plurality of candidate commodities is selected, the operator is urged to select one in these candidate commodities, one in these candidate commodities is determined to be the sales commodity according to the operation by the operator, and therefore, a recognition result is not uselessly canceled. In addition, in response to the cancellation instruction from the operator, the recognition result is cancelled. Therefore, the recognition result that the sales commodity cannot be correctly recognized is cancelled, and the reading processing of the sales commodity can be re-executed from the beginning.

The embodiment may be modified in various forms as following.

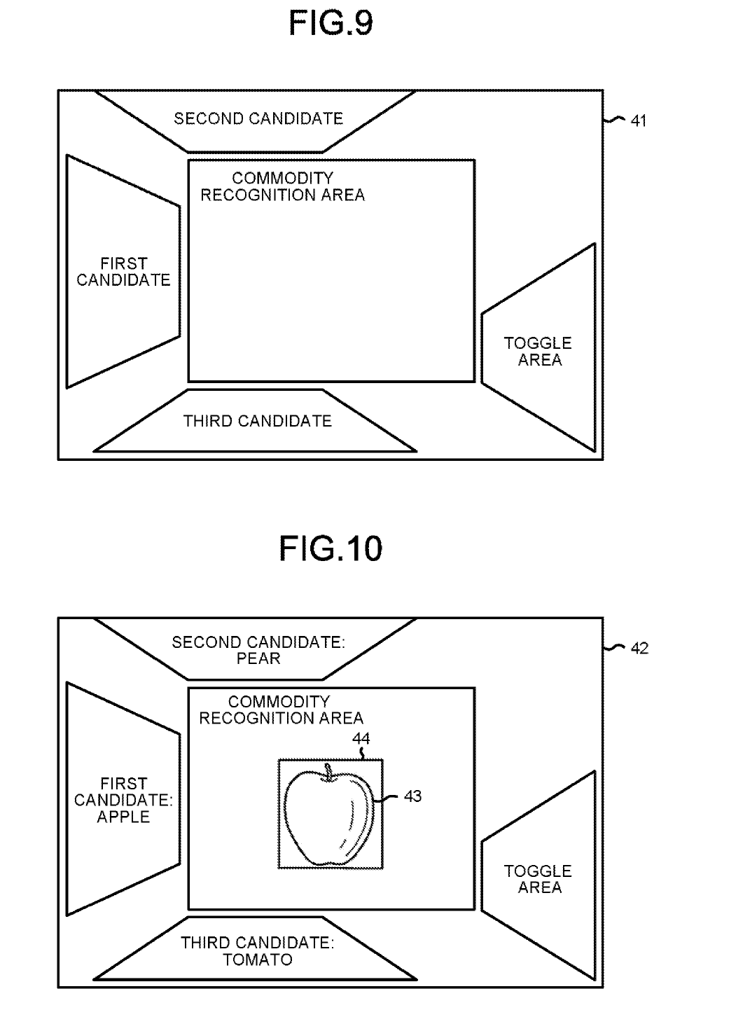

The CPU 106 generates a monitor image, for example, in which a guidance image 41 shown in FIG. 9 is overlaid on the animation acquired by the image capturing device 105a, may be displayed on the touch panel 103 beforehand. In this way, the operator can easily grasp a positional relationship between the sales commodity in the animation and each functional area. In this operation, the CPU 106 functions as a generation unit.

If there are a plurality of candidate commodities, a monitor image, for example, in which a guidance image 42 shown in FIG. 10 that shows the association between each candidate commodity and each candidate area, is overlaid on the animation acquired by the image capturing device 105a, may be displayed on the touch panel 103 beforehand. In this way, the operator can easily grasp which one of the candidate areas is selected when he or she moves the sales commodity to the candidate area to determine the sales commodity as a recognized commodity. An image 43 shown in FIG. 10 is apart of the animation, and is the sales commodity imaged in the animation. An image 44 shows an area which is recognized as an object. These two images 43 and 44 are overlaid on the animation together with the guidance image 42 to display those images all together.

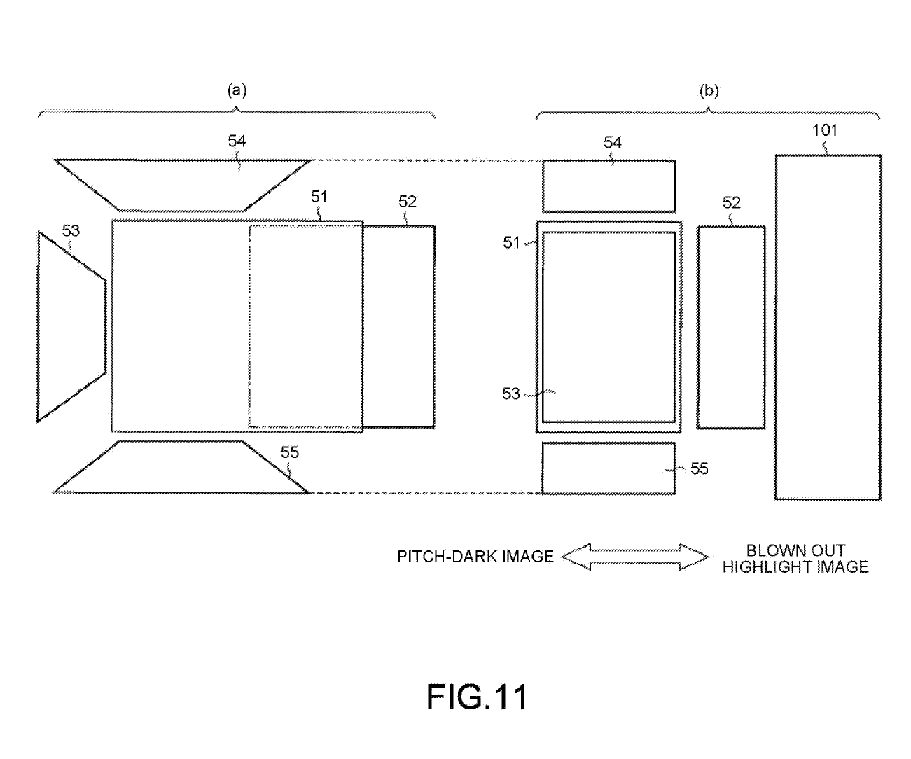

Each functional area can be set, for example, three-dimensionally as shown in FIG. 11.

FIG. 11 illustrates a modification of the definition of each functional area according to the setting information included in the area setting table. FIG. 11(a) illustrates arrangements of each functional area observed from the operator, and FIG. 11(b) illustrates arrangements of each functional area observed toward the standard line of flow from the upstream side of the standard line of flow.

In the example in FIG. 11, five functional areas, namely a recognition area 51, a toggle area 52, a first candidate area 53, a second candidate area 54 and a third candidate area 55, are defined.

The recognition area 51, the first candidate area 53, the second candidate area 54 and the third candidate area 55 have a positional relationship the same as that among the recognition area 11, the first candidate area 13, the second candidate area 14 and the third candidate area 15. However, the toggle area 52 deviates towards the housing 101 relative to the recognition area 51, the first candidate area 53, the second candidate area 54 and the third candidate area 55.

Therefore, the operator can select whether or not the sales commodity is moved through the toggle area 52 by adjusting the position of the sales commodity in a far-or-near direction relative to the housing 101.

The image capturing device 105a photographs an object such that the farther the object locates, the darker the object becomes, and thus, is able to estimate a distance from the image capturing device 105a to the sales commodity based on the brightness of the object in the animation. Therefore, it can be determined whether or not the sales commodity passes through the toggle area 52 according to the estimated distance.

If the candidate commodities are set to be two or more than four, the number of candidate areas may be set to the same as that of the candidate commodities.

If the sales commodity passes through the toggle area 12, the object recognition mode which is effective may be maintained even though the same sales commodity enters the toggle area 12 subsequently.

It may be determined by other detection device such as a photoelectronic sensor whether or not the sales commodity passes through the toggle area 12.

The operation by the operator for selecting the sales commodity from the candidate commodities may be received through the touch panel 103 and the like.

The processing mentioned above may also be carried out by acquiring the frame data obtained from an external image capturing device without mounting the image capturing section 105 in the commodity reading apparatus 100.

If the same function can be realized, a specific content in the processing by the CPU 106 may be changed.

For example, in the embodiment stated above, the commodity reading apparatus 100 has all functions for the commodity recognition, but such commodity recognition functions may be dispersed into the commodity reading apparatus 100 and the POS terminal 200. On the other hand, the POS terminal 200 may be further constituted to have all the functions for the commodity recognition.

A POS terminal or a cash register internally having the functions of the commodity reading apparatus 100 may also be arranged.

Furthermore, it may also be realized that the functions of the commodity reading apparatus 100 are incorporated into a self-checkout terminal with a weighing apparatus. In this case, a customer becomes an operator.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A commodity reading apparatus, comprising:
a discrimination unit configured to discriminate an object included in an animation which is captured by an image capturing device;
a determination unit configured to determine whether or not the object discriminated by the discrimination unit passes through a second area specified different from a first area in a frame range during movement of the object to the first area specified in the frame range of the animation;
a first recognition unit configured to recognize a candidate commodity as a candidate of a sales commodity based on a feature amount appeared on the object in the first area if the determination unit determines that the object passes through the second area; and
a second recognition unit configured to recognize a commodity data represented by an optical mark on the object in the first area if the determination unit determines that the object does not pass through the second area.

2. The commodity reading apparatus according to claim 1, wherein
the determination unit determines that the object passes through the second area if the discrimination unit continuously discriminates the object until the object is discriminated by the discrimination unit in the first area after the object is discriminated by the discrimination unit in the second area.

3. The commodity reading apparatus according to claim 1, further comprising:
a generation unit configured to generate a monitor image on which a guidance image showing the first area and the second area is overlaid in the animation.

4. The commodity reading apparatus according to claim 1, wherein if there are a plurality of candidate commodities recognized by the first recognition unit, at least two candidate commodities in the plurality of candidate commodities are associated with a plurality of third area specified different from the first and second areas beforehand, and further comprising a selection unit configured to select, if the discrimination unit discriminates the object in one of the plurality of third areas, the candidate commodity which is associated with the one third area as a sales commodity.

5. The commodity reading apparatus according to claim 1, further comprising:
a generation unit configured to generate a monitor image on which a guidance image showing the first area, the second area and the plurality of third areas are overlaid in the animation.

6. The commodity reading apparatus according to claim 5, wherein
the generation unit generates the guidance image showing which candidate commodity is associated with the plurality of third areas.

7. The commodity reading apparatus according to claim 1, wherein
the first area and the second area are set to be positioned along a line of flow of which an operator moves the sales commodity from the outside of an image capturing range of the image capturing device into the image capturing range and then to the outside of the image capturing range again.

8. A commodity sales data processing apparatus, comprising:
a discrimination unit configured to discriminate an object included in an animation which is captured by an image capturing device;
a determination unit configured to determine whether or not the object discriminated by the discrimination unit passes through a second area specified different from a first area in a frame range during movement of the object to the first area specified in the frame range of the animation;
a first recognition unit configured to recognize a candidate commodity as a candidate of a sales commodity based on a feature amount appeared on the object in the first area if the determination unit determines that the object passes through the second area;
a second recognition unit configured to recognize a commodity data represented by an optical mark on the object in the first area if the determination unit determines that the object does not pass through the second area; and
a registration unit configured to carry out sales registration on the sales commodity based on one of the candidate commodity recognized by the first recognition unit and the commodity data recognized by the second recognition unit.

9. A commodity reading method, including:
discriminating an object included in an animation captured by an image capturing device;
determining whether or not the discriminated object passes through a second area specified different from a first area in a frame range during movement of the object to the first area specified in the frame range of the animation;
recognizing a candidate commodity as a candidate of a sales commodity based on a feature amount appeared on the object in the first area if it is determined that the object passes through the second area; and
recognizing a commodity data represented by an optical mark on the object in the first area if it is determined that the object does not pass through the second area.
